(19) United States
(12) Patent Application Publication
(10) Pub. No.: US 2025/0134142 A1
(43) Pub. Date: May 1, 2025

(54) DUCK SKIN AND DUCK LIVER FOOD COMPOSITION AND METHOD OF MANUFACTURE

(71) Applicant: Jennifer Chamberlain, Auburn, NY (US)

(72) Inventor: Jennifer Chamberlain, Auburn, NY (US)

(21) Appl. No.: 18/932,134

(22) Filed: Oct. 30, 2024

Related U.S. Application Data
(60) Provisional application No. 63/594,102, filed on Oct. 30, 2023.

(51) Int. Cl. A23L 13/50; A23L 13/20; A23L 13/40; B65B 51/32; B65B 55/00

(52) U.S. Cl. CPC A23L 13/52; A23L 13/20; A23L 13/428; B65B 51/32; B65B 55/00

(57) ABSTRACT

A food product composition similar to foie gras includes a non-fattened duck liver and duck skin mixed with a plurality of ingredients in the following amounts per 2 pounds of non-fattened duck liver and duck skin placed in the bag: 0.2 pounds of white wine; 0.04 pounds of salt; 0.005 pounds of white pepper; 0.005 pounds of sugar; and 0.5 grams of nutmeg. The method for making the food product composition results in a food composition that closely mimics the flavor of traditional foie gras.

### CROSS-REFERENCE TO RELATED APPLICATION

The present application claims priority to U.S. Provisional Application No. 63/594, 102 filed on Oct. 30, 2023.

### FIELD OF THE INVENTION

The present disclosure is directed generally to a duck skin and duck liver food composition and a method for making the same.

### BACKGROUND

Duck skin and duck liver can be made to taste and be textured similarly to foie gras, but using different ingredients and processes.

Foie gras is a luxury food product made from the liver of ducks or geese. The process of making foie gras involves fattening the liver to produce a rich, buttery texture and flavor. There are traditional and modern methods for producing foie gras, but it's essential to note that the practice has raised ethical concerns related to animal welfare.

Typically, Mulard ducks or Landes geese are used to produce foie gras, as they have larger livers compared to other breeds. A principal step in foie gras production is force-feeding, which is known as “gavage.” The ducks or geese are are force-fed a special diet through a tube or funnel. This diet is high in energy and consists of corn or a mixture of corn and other grains. The force-feeding causes their livers to enlarge significantly. The ducks or geese are typically harvested when their livers have reached the desired size. The harvested liver is then processed. The liver is carefully removed from the bird and separated from any impurities or excess fat. It is usually chilled to make it easier to work with. Foie gras can be prepared in various ways, such as searing, poaching, or baking. It is often served in slices or pâté form.

There is a need in the art for an alternative method for making a duck skin and duck liver food product that is similar to the taste and texture of traditional foie gras.

### SUMMARY

The present disclosure is directed to a method of making a duck skin and duck liver food product and to the food product composition.

According to an aspect is a method for making a duck skin and duck liver food composition, comprising the steps of placing a non-fattened duck liver and duck skin in a bag; adding and sealing the following ingredients to the bag in the amounts per 2 pounds of non-fattened duck liver and duck skin placed in the bag: 0.2 pounds of white wine; 0.04 pounds of salt; 0.005 pounds of white pepper; 0.005 pounds of sugar; and 0.5 grams of nutmeg; cooking the ingredients and non-fattened duck liver and duck skin in the bag by either a sous vide method or in a steamed jacketed kettle with the water bath of 160-180 degrees Fahrenheit; removing the ingredients and non-fattened duck liver and duck skin in the bag from the cooking process when the desired temperature of the ingredients is reached; cooling the ingredients and non-fattened duck liver and duck skin in the bag to no more than 40 degrees Fahrenheit; whipping the ingredients and non-fattened duck liver and duck skin in the bag to a mousse consistency; packaging the whipped ingredients and non-fattened duck liver and duck skin into at least one container and sealing the at least one container with a tamper evident lid, and cooling the packaged ingredients and non-fattened duck liver and duck skin to a desired temperature; and, optionally, applying high pressure pasteurization to the packaged ingredients and non-fattened duck liver and duck skin.

According to an embodiment, the ratio used in the method of duck skin to duck liver is in the following ranges: 50%- 80% duck skin and 20%- 50% duck liver

According to an aspect is a food product composition, comprising a non-fattened duck liver and duck skin; a plurality of ingredients mixed with the non-fattened duck liver and duck skin in the following amounts per 2 pounds of non-fattened duck liver and duck skin placed in the bag: 0.2 pounds of white wine; 0.04 pounds of salt; 0.0005 pounds of white pepper; 0.0005 pounds of sugar; and 0.5 grams of nutmeg.

According to an embodiment, the ratio in the composition of duck skin to duck liver is in the following ranges: 50%- 80% duck skin and 20%- 50% duck liver.

These and other aspects of the invention will be apparent from the embodiments described below.

### DETAILED DESCRIPTION OF EMBODIMENTS

The present disclosure describes a duck skin and duck liver food product composition and a method for making the food product.

In one embodiment, the food product is made of non-fattened duck liver. duck skin and different seasonings to mimic the flavor of foie gras (Goose liver and duck liver, foie gras, (fat liver) are obtained exclusively from specially fed and fattened geese and ducks, https://www.fsis.usda.gov/sites/default/files/import/Labeling-Policy-Book.pdf).

The non fattened duck liver and duck skin is placed in a bag, white wine and seasonings in amounts stated below. The ratio of duck skin to duck liver can range from, duck skin 50-80% and duck liver 20-50%.

Other ingredients per 2 lbs. of liver and skin mix (meat block):
sweet, white wine 0.2 lbs. +/−0.001 lbs
kosher, salt 0.04 lbs. +/−0.001 lbs
white pepper 0.005 lbs. +/−0.001 lbs
sugar, white 0.005 lbs +/−0.001 lbs
nutmeg 0.5 grams +/−0.001 lbs

The sealed product is cooked via the sous vide method (controlled temperature water bath with immersion circulator) or in a steam jacketed kettle with the water bath temperature of 160-180* Fahrenheit. The product can be cooked and held to temperatures stated on pg 16 of the USDA Time and Temperature Table for Ready to Eat Poultry products for products with 12% fat or higher.

Once the product has cooled to 40° F. or below it is whipped using a food processor to a mousse consistency and packaged into deli cup container with a tamper evident lid or terrine mould, sealed and cooled again. The product is then sent for high pressure pasteurization treatment at a 3rd party facility to kill any pathogens the product may have been introduced to post lethality treatment. The form of the food product is that of a mousse/bloc, torchon or terrine stye ready to eat product; it is not necessarily a searable food product. For packaging, the food product can be packed in deli cups, terrine moulding, plastic tubing, or 2-7 mm vac sealed bags. Finally, the food product can be uncured, or cured with celery root powder or with pink salt (e.g., Prague powder curing salt #1) according to USDA guidelines for comminuted products.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A method for making a duck skin and duck liver food product, comprising the steps of:
a. placing a non-fattened duck liver and duck skin in a bag;
b. adding and sealing the following ingredients to the bag in the amounts per 2 pounds of non-fattened duck liver and duck skin placed in the bag:
i. 0.2 pounds of white wine;
ii. 0.04 pounds of salt;
iii. 0.005 pounds of white pepper;
iv. 0.005 pounds of sugar; and
v. 0.5 grams of nutmeg;
c. cooking the ingredients and non-fattened duck liver and duck skin in the bag by either a sous vide method or in a steamed jacketed kettle with the water bath of 160-180 degrees Fahrenheit;
d. removing the ingredients and non-fattened duck liver and duck skin in the bag from the cooking process when the desired temperature of the ingredients is reached;
e. cooling the ingredients and non-fattened duck liver and duck skin in the bag to no more than 40 degrees Fahrenheit;
f. whipping the ingredients and non-fattened duck liver and duck skin in the bag to a mousse consistency; and
g. packaging the whipped ingredients and non-fattened duck liver and duck skin into at least one container, and cooling the packaged ingredients and non-fattened duck liver and duck skin to a desired temperature.

2. The method according to claim 1, further comprising the step of applying high pressure pasteurization to the packaged ingredients and non-fattened duck liver and duck skin.

3. The method according to claim 1, wherein the ratio of duck skin to duck liver is in the following ranges: 50%- 80% duck skin and 20%- 50% duck liver.

4. The method according to claim 1, wherein the packaging can be in any of deli cups, terrine moulding, plastic tubing, or 2-7 mm vac sealed bags.

5. A food product composition, comprising:
a. a non-fattened duck liver and duck skin;
b. a plurality of ingredients mixed with the non-fattened duck liver and duck skin in the following amounts per 2 pounds of non-fattened duck liver and duck skin placed in the bag:
i. 0.2 pounds of white wine;
ii. 0.04 pounds of salt;
iii. 0.0005 pounds of white pepper;
iv. 0.0005 pounds of sugar; and
v. 0.5 grams of nutmeg.

6. The composition according to claim 5, wherein the ratio of duck skin to duck liver is in the following ranges: 50%- 80% duck skin and 20%- 50% duck liver.
